(19) United States
(12) Patent Application Publication
(10) Pub. No.: US 2021/0245739 A1
(43) Pub. Date: Aug. 12, 2021

(54) ANALYTICS AND RISK ASSESSMENT FOR SITUATIONAL AWARENESS

(71) Applicant: INTERNATIONAL BUSINESS MACHINES CORPORATION, Armonk, NY (US)

(72) Inventors: David Verburg, Mantorville, MN (US); Eric V. Kline, Pine Island, MN (US); Sarbajit K. Rakshit, Kolkata (IN)

(21) Appl. No.: 16/787,123

(22) Filed: Feb. 11, 2020

(51) Int. Cl. B60W 30/09; G07C 5/08; B60W 50/08; G08G 1/01; G08G 1/16

(52) U.S. Cl. CPC B60W 30/09; G07C 5/085; B60W 50/08; B60W 2554/408; G08G 1/163; G08G 1/166; G08G 1/0125

(57) ABSTRACT

A method for performing an action based on risk assessment includes identifying a subject vehicle in a vicinity of a traveling vehicle, wherein the vicinity is based on a direction of travel and a distance between the subject vehicle and the traveling vehicle. The method receives a plurality of observations from a device on the traveling vehicle, where the plurality of observations includes at least one vehicle observation that identifies a feature on the subject vehicle that affects operational safety of the subject vehicle and the traveling vehicle. The method generates an updated risk assessment score for the subject vehicle based on the one or more observations and an initial risk assessment score for the subject vehicle. The method, responsive to determining an action for the traveling vehicle to perform based on the updated risk assessment score for the subject vehicle, performs the action at the traveling vehicle.

### BACKGROUND OF THE INVENTION

This disclosure relates generally to analytics and risk assessment and in particular to utilizing analytics and risk assessment for situational awareness.

Presently, safety systems installed on mechanically operated machinery are reaction based, where a safety system detects an event (e.g., an obstacle) and reacts accordingly to the event to prevent an incident due to the detected event. Though safety systems utilize a massive amount of computing power to calculate an appropriate reaction subsequent to detection, there are instances where the calculated reaction will not prevent the incident from occurring.

### SUMMARY

Embodiments in accordance with the present invention disclose a method, computer program product and computer system for performing an action based on risk assessment, the method, computer program product and computer system can identify a subject vehicle in a vicinity of a traveling vehicle, wherein the vicinity is based on a direction of travel and a distance between the subject vehicle and the traveling vehicle. The method, computer program product and computer system can receive a plurality of observations from one or more devices on the traveling vehicle, wherein the plurality of observations includes at least one vehicle observation that identifies a feature on the subject vehicle that affects operational safety of the subject vehicle and the traveling vehicle. The method, computer program product and computer system can generate an updated risk assessment score for the subject vehicle based on the one or more observations from the one or more device on the traveling vehicle and an initial risk assessment score for the subject vehicle. The method, computer program product and computer system can, responsive to determining an action for the traveling vehicle to perform based on the updated risk assessment score for the subject vehicle, perform the action at the traveling vehicle.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a risk assessment program for performing an action based on risk assessment, in accordance with an embodiment of the present invention.

FIG. 3 illustrates an example of a traveling vehicle utilizing a risk assessment program, in accordance with an embodiment of the present invention.

FIG. 4 is a block diagram of components of a computer system, such as the server computer of FIG. 1, in accordance with an embodiment of the present invention.

FIG. 5 depicts a cloud computing environment, in accordance with an embodiment of the present invention.

FIG. 6 depicts abstraction model layers, in accordance with an embodiment of the present invention.

### DETAILED DESCRIPTION

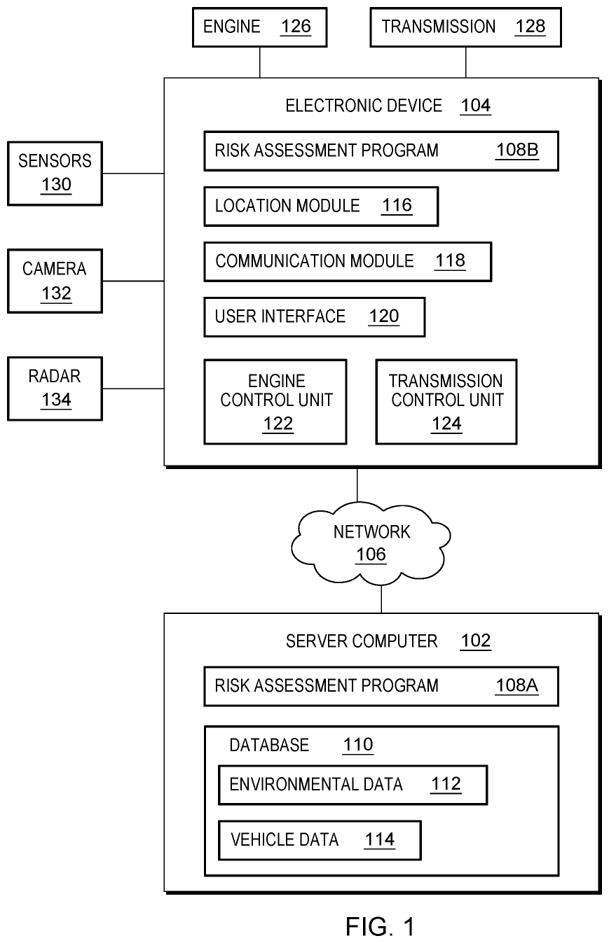

FIG. 1 is a functional block diagram illustrating a distributed data processing environment, in accordance with one embodiment of the present invention. The distributed data processing environment includes server computer 102 and electronic device 104 all interconnected over network 106. For discussion purposes, risk assessment program 108 can operate on server side as risk assessment program 108A on server computer 102 or user side as risk assessment program 108B on electronic device 104.

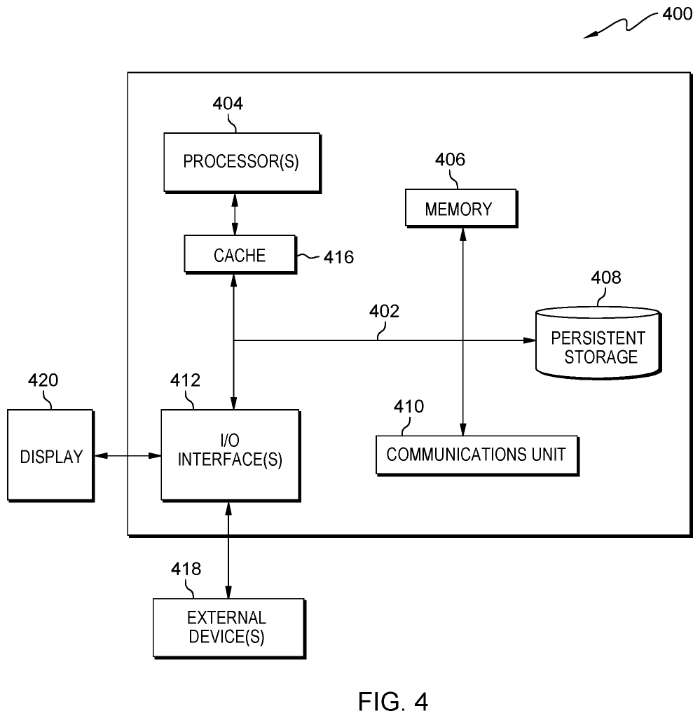

Server computer 102 may be a desktop computer, a laptop computer, a tablet computer, a specialized computer server, a smartphone, or any computer system capable of executing the various embodiments of risk assessment program 108A. In certain embodiments, server computer 102 represents a computer system utilizing clustered computers and components that act as a single pool of seamless resources when accessed through network 106, as is common in data centers and with cloud computing applications. In general, server computer 102 is representative of any programmable electronic device or combination of programmable electronic devices capable of executing machine-readable program instructions and communicating with other computer devices via a network. In this embodiment, server computer 102 has the ability to communicate with other computer devices to query the computer devices for information. Server computer 102 includes risk assessment program 108A, database 110, environmental data 112, and vehicle data 114. In this embodiment, risk assessment program 108A represents a server-side based risk assessment program 108. Server computer 102 may include internal and external hardware components, as depicted and described in further detail with respect to FIG. 4.

Electronic device 104 may be a microprocessor, a microcontroller, or any computing device capable of integrating functions of risk assessment program 108B, location module 116, communication module 118, user interface 120, engine control unit (ECU) 122, and transmission control unit (TCU) 124. Alternatively, risk assessment program 108B, location module 116, communication module 118, user interface 120, ECU 122, and TCU 124 each operate independently without electronic device 104 utilizing a Controller Area Network (CAN bus). User interface 120 of electronic device 104 allows for a user (i.e., vehicle operator) to interact with and communicate with risk assessment program 108B. In this embodiment, risk assessment program 108B represents a user side (i.e., vehicle operator) based risk assessment program 108. In general, electronic device 104 is representative of any programmable electronic device or combination of programmable electronic devices capable of executing machine-readable program instructions and communicating with users of other electronic devices via network 106. Electronic device 104 may include components, as depicted and described in further detail with respect to FIG. 4, in accordance with embodiments of the present invention.

In general, network 106 can be any combination of connections and protocols that will support communications between server computer 102 and electronic device 104. Network 106 can include, for example, a local area network (LAN), a wide area network (WAN), such as the internet, a cellular network, or any combination of the preceding, and can further include wired, wireless, and/or fiber optic connections. In one embodiment, risk assessment program 108A can be a web service accessible via network 106 to a user of electronic device 104. In another embodiment, risk assessment program 108A may be operated directly by a user of server computer 102.

Risk assessment program 108 utilizes environmental data 112 and surrounding vehicle data 114 to perform risk assessment for a traveling vehicle and performing an appropriate action in response to the risk assessment. Risk assessment program 108 receives data collected from multiple vehicles (i.e., vehicle data 114) and performances an initial risk assessment for the multiple vehicles based on the received data that was collected. As vehicle is traveling, risk assessment program 108 identifies another vehicle in a vicinity to the traveling vehicle. Risk assessment program 108 receives vehicle, driver, and environmental observations, wherein vehicle observations includes data collected from sensors 130, camera 132, radar 134 on the traveling vehicle, driver observations includes information provided by the user of the traveling vehicle via user interface 120, and environmental observation includes data collected from the the traveling vehicle and publicly available environmental data 112. Risk assessment program 108 generates an updated risk assessment for the identified vehicle and determines an action based on the updated risk assessment, wherein the action is to be taken by the traveling vehicle in response to the updated risk assessment. Risk assessment program 108 performs the actions and responsive to determining the identified vehicle is still in a vicinity of the traveling vehicle, risk assessment program 108 reverts back and receives vehicle, driver, and environmental observations to generate another updated risk assessment for the identified vehicle until the identified vehicle is no longer in the vicinity.

Database 110 is a repository for data (e.g., environmental data 112 and vehicle data 112) utilized by risk assessment program 108. In the depicted embodiment, database 110 resides on server computer 102. In another embodiment, database 110 may reside on another device (not illustrated in FIG. 1) within the distributed data processing environment provided risk assessment program 108 has access to database 110. A database is an organized collection of data. Database 110 can be implemented with any type of storage device capable of storing data and configuration files that can be accessed and utilized by risk assessment program 108, such as a database server, a hard disk drive, or a flash memory. In this embodiment, database 110 stores data utilized by risk assessment program 108 that includes environmental data 112 and vehicle data 114.

Environment data 112 includes any weather condition information and road condition information, where environmental data 112 is freely available or accessible via a subscription-based service and/or previously collected by sensors 130, camera 132, and radar 134 on the traveling vehicle. Weather condition information includes but is not limited to wind speed, type of precipitation, precipitation rates, humidity levels, dew point temperature, ambient temperature, and visibility distances. Environment data 112 can also include warnings (e.g., winter storm warning or tornado warning) issued by an agency, such as the National Weather Service (NWS), relating to extreme or hazardous related weather events. Road condition information includes but is not limited to road surface condition (e.g., potholes, ice), traffic information, accident information, debris information (e.g., fallen tree), disabled vehicle, and road works. Risk assessment program 108 has the ability to ability to receive and analyze environment data 112 to generate an updated risk assessment for an identified vehicle in a vicinity of the traveling vehicle.

Vehicle data 114 includes manufacturer information for a vehicle based on a make, model, and/or Vehicle Identification Number (VIN). The manufacture information can include brake distances in the dry and wet with no payload, brake distances in the dry and wet with max payload, wading depth, and safety equipment installed on the vehicle. Vehicle data 114 can further includes service interval information (e.g., miles until next service) for one or more components (e.g., brakes) on a vehicle, data collected for a vehicle during a previous inspection (e.g., tire tread depth, remaining brake pad material), and one or more service codes (e.g., low brake pad warning, ABS fault) produced by the vehicle. A vehicle (e.g., the traveling vehicle or the identified vehicle) can include safety equipment such as, sensors 130, camera 132, and radar 134. Risk assessment program 108 has the ability to ability to receive and analyze vehicle data 112 to generate an updated risk assessment for an identified vehicle in a vicinity of the traveling vehicle. Vehicle data 114 can include information gathered from location module 116, communication module 118, engine control unit 122, transmission control unit 124, sensors 130, camera 132, and radar 134.

Location module 116 allows for risk assessment program 108 to identify a location of a traveling vehicle with electronic device 104. In this embodiment, location module 116 is a Global Positioning System (GPS) that risk assessment program 108 utilizes to monitor a location for the vehicle. Communication module 118 allows for risk assessment program 108B to communicate with risk assessment program 108A on server computer 102, via network 106. User interface 120 enables a user to make requests of or issue commands to electronic device 104 and receive information and instructions in response. In one embodiment, user interface 120 is a voice user interface (VUI) for a user of electronic device 104 to access via voice commands in natural language. In one embodiment, user interface 120 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 120 enables a user of electronic device 104 to interact with risk assessment program 108.

Engine control unit (ECU) 122, also known as an engine control module (ECM), is an electronic device that controls and monitors various actuators of engine 126. ECU 122 utilizes a software component capable of controlling and monitoring performance output and operation parameters of engine 126. Transmission control unit (TCU) 124 is an electronic device that controls and monitors various parameters of transmission 128. Similar to ECU 122, TCU 124 utilizes a software component capable of controlling and monitoring performance output and operational parameters of transmission 128.

Sensors 130, camera 132, and radar 134 represent hardware from which risk assessment program 108 receives vehicle data 114 to perform an initial risk assessment and an updated risk assessment for the identified vehicle. Sensors 130 can include electromagnetic, ultrasonic, sonar, lidar, laser, and camera detection systems integrated into various driver assistance systems such as parking assist systems, blind spot monitoring, lane keeping system, and rear cross traffic alert systems. Camera 132 represents a device capable of capturing optical or infrared images or videos. Camera 132 allow for detection of heat signatures from humans, wildlife, and other vehicles and are beneficial for instances of low visibility (i.e., dense fog, roadside debris). Camera 132 also has the ability to capture environmental data 112 including but not limited to rain, snow, hail, and sunlight glare. Radar 134 represents a device capable of detecting objects in a line of sight of radar 134 and is typically integrated into various driver assistance systems such as, adaptive cruise control.

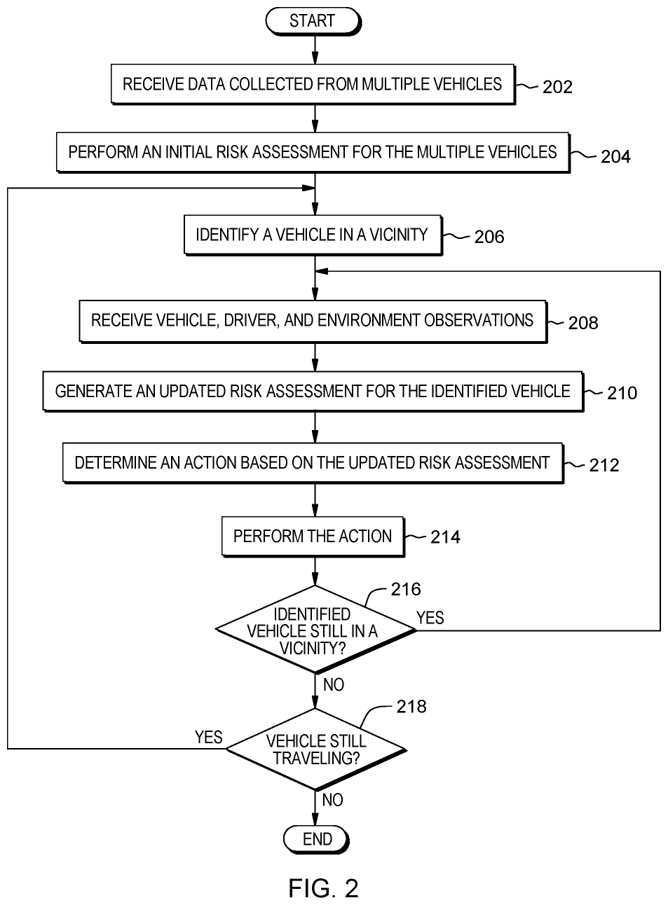

FIG. 2 is a flowchart depicting operational steps of a risk assessment program for performing an action based on risk assessment, in accordance with an embodiment of the present invention.

Risk assessment program 108 receives (202) data collected from multiple vehicles. In this embodiment, risk assessment program 108 receives data collected by one or more devices on each of the multiple vehicles, where a user associated with each vehicle from the multiple vehicles has previously opted in to share data collected by the one or more devices. Each vehicle includes a unique identifier (e.g., VIN) to allow for risk assessment program 108 to associate the received data with a given vehicle, where the unique identifier can include information such as make, model, year, and one or more devices present on the given vehicle. Furthermore, risk assessment program 108 can utilize a location module (e.g., GPS) and the unique identifier to identify a vehicle in a vicinity of a traveling vehicle. The one or more devices on each of the multiple vehicles can include sensors, cameras, radars, engine control units, transmission control units, and any other electronic device capable of capturing information regarding an operation of an associated vehicle. The data collected by the one or more device on each of the multiple vehicles can indicate whether the device is operating properly, producing a fault code, or registering an event. Risk assessment program 108 can receive the data collected by the one or more devices on each of the multiple vehicles in predetermined intervals, such as, time-based intervals (e.g., every 5 minutes) and/or mileage-based intervals (e.g., every 5 miles traveled).

In one example, risk assessment program 108 receives data collected from a vehicle that has a front mounted radar, an engine control unit, and a transmission control unit. That data indicates that the engine control unit and the transmission control unit do not have any stored fault codes, whereas the front mounted radar has a fault code indicating an obstruction of the radar is occurring and that the functions of the front mounted radar are limited. Since the front mounted radar is utilized by the vehicle for one or more safety features (e.g., pedestrian detection), risk assessment program 108 utilizes this received data collected from the vehicle when performing an initial risk assessment for the vehicle. In another example, risk assessment program 108 receives data collected from a rain sensor and an abs sensor on a vehicle, where the rain sensor indicates precipitation and the abs sensor detects a fault. Furthermore, the rain sensor indicates a wiper system on the vehicle is manual set to a frequency setting lower than a predetermined frequency setting for the amount of precipitation that rain sensor is indicating (i.e., the wiper system are not clearing the windshield frequently enough with respect to the amount of falling precipitation). In yet example, risk assessment program 108 receives data collected from a front mounted radar system, brake pad sensor, and engine control unit on a vehicle. The front mounted radar system indicates the vehicle is tailgating another vehicle based on a speed and distance between the two vehicles, the brake pad sensor indicates the brake pads are worn, and the engine control unit indicates the driver of the vehicle is aggressive depressing (e.g., 80% depressed) the accelerator pedal and brake pedal in short intervals (e.g., every 5-7 seconds).

Risk assessment program 108 performs (204) an initial risk assessment for the multiple vehicles. Based on the received data collected from the multiple vehicles, risk assessment program 108 performs an initial risk assessment for each of the multiple vehicles. As previously discussed, risk assessment program 108 receives data collected by the one or more devices on each of the multiple vehicles in predetermined intervals and as a result, risk assessment program 108 can perform the initial risk assessment for each of the multiple vehicles at the predetermined intervals. Risk assessment program 108 performs the initial risk assessment for each vehicle by generating an overall risk assessment score based on a driver score, a vehicle score, and an environment score. The driver score represents a level of safety at which a user (i.e., driver) is operating a vehicle, where a higher driver score represents a user operating a vehicle in a safe manner (e.g., maintaining distance between vehicles, signaling, progressive braking) and a lower driver score represents a user operating a vehicle in a hazardous manner (e.g., tailgating, not maintaining a lane, aggressive braking). The vehicle score represents a condition of a vehicle the user is operating, where a higher vehicle score represents a maintained vehicle (e.g., up-to-date maintenance, no sensors fault codes) and a lower vehicle score represents a vehicle that requires maintenance (e.g., sensor fault codes, low brake pad warning). The environment score represents surrounding conditions in which the vehicle is operating, where a higher score represents optimal conditions for driving (e.g., partly cloudy, above 0° C. temperatures) and a lower score represents hazardous conditions for driving (e.g., fog, snow, below 0° C. temperatures). Risk assessment program 108 can further assign a weight to each of the driver score, the vehicle score, and the environment score, to prioritize one score (e.g., vehicle score) over another score (e.g., driver score).

In this embodiment, risk assessment program 108 generates the driver score, the vehicle score, and the environment score for each vehicle based on the received data collected for the multiple vehicles. Risk assessment program 108 generates the overall risk assessment score by combining (i.e., summation) the driver score, the vehicle score, and the environment score. As previously discusses, risk assessment program 108 can further assign a weight to the various scores. For example, a maximum score for each of the driver score, the vehicle score, and the environment score is 25 with a total score of 75, where risk assessment program 108 determines a driver score of 18, a vehicle score of 22, and an environment score of 20. Risk assessment program 108 assigns a weight of 1.25 to the vehicle score, 1.25 to the environment score, and 0.5 to the driver score. Therefore, risk assessment program 108 calculates the overall risk assessment score as, 1.25*(20)+1.25*(22)+0.5*(18)=61.5 (versus 60 without weighting). Risk assessment program 108 can further utilize a segmented scoring criterion to determine a level of risk based on the overall risk assessment score. For example, scores in the range of 75≥x≥65, risk assessment program 108 considers to be low risk. Scores in the range of 65>x≥55, risk assessment program 108 considers to be moderate risk and scores that are 55>x, risk assessment program 108 considers to be high risk.

Risk assessment program 108 identifies (206) a vehicle in a vicinity. In this embodiment, risk assessment program 108 identifies a vehicle (i.e., subject vehicle) in a vicinity of a traveling vehicle, wherein the vicinity is based on a direction of travel, an approaching speed between the subject vehicle and the traveling vehicle, and a distance between the subject vehicle and the traveling vehicle. The direction of travel indicates whether the traveling vehicle is moving in a similar direction or opposite direction relative to the subject vehicle. The approaching speed represents a speed of the traveling vehicle relative to the subject vehicle, whether the vehicles are traveling in the same direction or opposite direction. The distance between the subject vehicle and the travel vehicle relates to the direction of travel and the approaching speed. For example, if the traveling vehicle is approaching the subject vehicle while traveling in the opposite direction, risk assessment program 108 utilizes a larger distance between the subject vehicle and the traveling vehicle, resulting in a greater area for the defined vicinity. If the traveling vehicle is approaching the subject vehicle while traveling in the same direction risk assessment program 108 utilizes a smaller distance between the subject vehicle and the traveling vehicle, resulting in a smaller area for the defined vicinity. In other embodiments, the vicinity is defined by a distance that at least one device (e.g., radar) on the traveling vehicle is capable of detecting the subject vehicle. In yet another embodiment, the vicinity is defined by a greater distance of at least two distances that at least two devices on the traveling vehicle are capable of detecting the subject vehicle. For example, if a radar device on the traveling vehicle is capable of detecting the subject vehicle at 2500 feet and a camera device on the traveling vehicle is capable of detecting the subject vehicle at only 1000 feet, risk assessment program 108 utilizes the greater distance (i.e., 2500 feet) of the two distances to establish the area for the vicinity.

Risk assessment program 108 receives (208) vehicle, driver, and environmental observations. Risk assessment program 108 has the ability to receive subject vehicle, driver, and environmental observations from one or more devices on the traveling vehicle and/or directly from the user (i.e., driver) of the traveling vehicle via a user interface. Risk assessment program 108 receives vehicle observations captured by the one or more devices on the traveling vehicle and utilizes image processing software to identify one or more features on the subject vehicle, wherein the one or more features on the subject vehicle affect the vehicle score and operational safety of the subject vehicle. The one or more identifiable features include but are not limited to a nonfunctioning headlight, a nonfunction tailing light, a missing side mirror, an unsecured load, unremoved rooftop snow, a deflated tire, an open panel (e.g., trunk), and any other feature that can affect the operational safety of the vehicle.

In one example, risk assessment program 108 receives vehicle observations in the form of multiple images captured by a camera on a traveling vehicle of the subject vehicle. Risk assessment program 108 identifies features on the subject vehicle that would affect the vehicle score utilizing image processing software, where the features include a missing driver side mirror on the subject vehicle and unremoved snow on the rooftop of the subject vehicle. The missing driver side mirror can negatively affect operational safety when the driver of the subject vehicle performs a lane changes and the unremoved snow on the rooftop of the subject can negatively affect operational safety of any surrounding traveling vehicle. Risk assessment program 108 can also identify a make, model, year, one or more devices, and any modifications performed to the subject vehicle based on previously received data collected from one or more devices on the subject vehicle and the unique identifier for the subject vehicle. For example, if risk assessment program 108 previously received data from the subject vehicle indicating a driver's side mirror circuit fault, risk assessment program 108 analyzes the captured images of the subject vehicle to identify whether or not the driver's side mirror is present on the subject vehicle. In another example, risk assessment program 108 receives vehicle observations in the form of multiple images captured by an infrared camera on a traveling vehicle of the subject vehicle. Risk assessment program 108 identifies features on the subject vehicle that would affect the vehicle score utilizing image processing software, where the features include an abnormal heat signature (i.e., temperature above a threshold) from a brake system on the subject vehicle. The abnormal heat signature from the braking systems indicates that the braking system on the subject vehicle is overheating and the subject vehicle may require additional distance to perform an emergency stop. In yet another embodiment, risk assessment program 108 receives vehicle observations directly from the user (i.e., driver) of the traveling vehicle via a user interface input and/or selection, where risk assessment program 108 displays an image of the subject vehicle and one or more, user interface selectable, features that affect the vehicle score and operational safety of the subject vehicle.

Risk assessment program 108 receives driver observations captured by the one or more devices on the traveling vehicle, where driver observations are based on actions performed by the subject vehicle as a result of driver input that affect the driver score. For example, risk assessment program 108 receives driver observations for the subject vehicle from a front mount radar system that indicate the subject vehicle positioned in front of the traveling vehicle is accelerating and braking aggressively based on a varying distance between the subject vehicle and travel vehicle relative to the actions performed by the traveling vehicle. If the traveling vehicle is moving at a constant speed (e.g., 60 mph) and the distance between the subject vehicle and travel is varying rapidly, risk assessment program 108 determines the subject vehicle is accelerating and braking aggressively. In another example, risk assessment program 108 receives driver observations for the subject vehicle from a front mounted windshield camera that indicate the subject vehicle in front of the traveling vehicle is performing lane changes without signaling and failing to maintain a lane. In yet another embodiment, risk assessment program 108 receives driver observations directly from the user (i.e., driver) of the traveling vehicle via a user interface input and/or selection, where risk assessment program 108 displays an image of the subject vehicle and one or more, user interface selectable, driver actions (e.g., failure to maintain lane) that affect the driver score and operational safety of the subject vehicle.

Risk assessment program 108 receives environment observation captured by the one or more devices on the traveling vehicle, where the environment observation affects the environment score and the operational capabilities of the subject vehicle. For example, risk assessment program 108 receives environmental observations for the subject vehicle from a rain sensor and a temperature sensor on the traveling vehicle, where the rain sensor detects the presence of precipitation and the temperature sensor indicated below freezing temperatures (e.g., −5° C.). Since risk assessment program 108 determined the subject vehicle is in the vicinity of the traveling vehicle, risk assessment program 108 applies the environmental observations captured by the rain sensor and the temperature sensor on the traveling vehicle to the subject vehicle as well. In another example, risk assessment program 108 receives environment observations for the subject vehicle from a front mounted camera on the traveling vehicle, where the front mount camera detects the presence of a glare due to a direction of the sunlight. Since risk assessment program 108 determined the subject vehicle is in the vicinity of the traveling vehicle and traveling in the same direction, risk assessment program 108 applies the environment observation captured by the front mounted camera on the traveling vehicle to the subject vehicle as well. In yet another embodiment, risk assessment program 108 receives environment observations directly from the user (i.e., driver) of the traveling vehicle via a user interface input and/or selection, where risk assessment program 108 displays an image of the subject vehicle and one or more, user interface selectable, environment conditions (e.g., ice, sunlight glare) that affect the environment score and operational safety of the subject vehicle.

Risk assessment program 108 generates (210) an updated risk assessment for the identified vehicle. In this embodiment, risk assessment program 108 utilizes the received vehicle, driver, and environment observations to generate an updated risk assessment for the subject vehicle based on the initial risk assessment previously performed for the subject vehicle. In another embodiment, risk assessment program 108 utilizes the received vehicle, driver, and environment observation to generate an updated risk assessment for the subject vehicle, where risk assessment program 108 did not previously perform an initial risk assessment for the subject vehicle. Similar to performing the initial risk assessment as discussed above, risk assessment program 108 performs the updated risk assessment for the subject vehicle by generating an updated overall risk assessment score based on a driver score, a vehicle score, and an environment score. The driver score represents a level of safety at which a user (i.e., driver) is operating a vehicle, where a higher driver score represents a user operating a vehicle in a safe manner and a lower driver score represents a user operating a vehicle in a hazardous manner. The vehicle score represents a condition of a vehicle the user is operating, where a higher vehicle score represents a subject vehicle without any features that negatively affects an operational safety of the subject vehicle and a lower vehicle score represents a subject vehicle with one or more features that negatively affect the operational safety of the subject vehicle. The environment score represents surrounding conditions in which the vehicle is operating, where a higher score represents optimal conditions for driving and a lower score represents hazardous conditions for driving. Risk assessment program 108 can further assign a weight to each of the driver score, the vehicle score, and the environment score, to prioritize one score (e.g., vehicle score) over another score (e.g., driver score).

In one example, risk assessment program 108 determined a driver score of 18, a vehicle score of 22, and an environment score of 20 for a subject vehicle and calculated the overall risk assessment score to be 61.5 (with weighting) for the subject vehicle. Based on the received vehicle, driver, and environment observation, risk assessment program 108 determines an identified feature on the subject vehicle (e.g., missing driver's side mirror) negatively affects the operational safety of the subject vehicle and risk assessment program 108 reduces the vehicle score from 22 to 18. Additionally, risk assessment program 108 determines an action performed by the subject vehicle as a result of driver input (e.g., failure to signal) negatively affects the operational safety of the subject vehicle and risk assessment program 108 reduces the driver score from 18 to 14. Risk assessment program 108 calculates the updated overall risk assessment score as, 1.25*(20)+1.25*(18)+0.5*(14)=54.5 and determines the subject vehicle has moved from the moderate risk category (65>x≥55) to the high risk category (55>x).

In another example, risk assessment program 108 determined a driver score of 25, a vehicle score of 25, and an environment score of 22 for a subject vehicle and calculated the overall risk assessment score to be 71.25 (with weighting) for the subject vehicle. Based on the received vehicle, driver, and environment observation, risk assessment program 108 determines an environment condition (e.g., snow) negatively affects the operational safety of the subject vehicle and risk assessment program 108 reduces the environment score from to 22 to 10. Additionally, risk assessment program 108 determines an identified feature on the subject vehicle (e.g., unremoved rooftop snow) negatively affects the operational safety of the subject vehicle and risk assessment program 108 reduces the vehicle score from 25 to 20. Risk assessment program 108 calculates the updated overall risk assessment score as, 1.25*(20)+1.25*(10)+0.5*(25)=50 and determines the subject vehicle has moved from the low risk category (75≥x≥65) to the high risk category (55>x).

Risk assessment program 108 determines (212) an action based on the updated risk assessment. The action is to be performed by the traveling vehicle in response to the updated overall risk assessment score for the subject vehicle located in the vicinity of the traveling vehicle. Risk assessment program 108 determines an action performable by the traveling vehicle in an autonomous manner without user (i.e., driver) input or by the driver of the traveling vehicle via manual inputs. Alternatively, risk assessment program 108 can determine to perform no action based on the updated risk assessment. In one example, risk assessment program 108 determines the subject vehicle has moved from a moderate risk category to a high risk category based on the updated overall risk assessment score due to the subject vehicle missing a driver's side mirror and the driver of the subject vehicle failing to signal while performing a lane change. Risk assessment program 108 determines an action to proactively mitigate any risk experienced by the traveling vehicle due to the subject vehicle, where the action includes the traveling vehicle by performing a lane change to separate the subject vehicle and the travel vehicle by at least one lane of traffic. Alternatively, risk management program 108 determines multiple actions to proactively mitigate any risk experienced by the traveling vehicle due to the subject vehicle, where the actions includes the traveling vehicle reducing a traveling speed to increase a distance between the subject vehicle and the traveling vehicle, the traveling vehicle performing a lane change to increase a distance between the subject vehicle and the traveling vehicle, and the traveling vehicle altering an intended route with the subject vehicle to a new route without the subject vehicle.

In another example, risk assessment program 108 determines the subject vehicle has moved from a low risk category to a high risk category based on the updated overall risk assessment score due to the environment condition (i.e., snow) and the subject vehicle having unremoved rooftop snow. Risk assessment program 108 determines an action to proactively mitigate any risk experienced by the traveling vehicle due to the subject vehicle, where the action includes the traveling vehicle reducing a traveling speed to increase a distance between the subject vehicle and the traveling vehicle. Alternatively, risk management program 108 determines multiple actions to proactively mitigate any risk experienced by the traveling vehicle due to the subject vehicle, where the actions include reducing a traveling speed to increase a distance between the subject vehicle and the traveling vehicle and sending a displayable notification to the subject vehicle indicating the unremoved rooftop snow poses a risk to other traveling vehicle. Risk assessment program 108 can protect the identity of the traveling vehicle that includes the one or more devices that captured the feature on the subject vehicle by not identifying which other vehicles are at risk due to the unremoved rooftop snow.

Risk assessment program 108 performs (214) the action. Based on user (i.e., driver) preferences of the traveling vehicle, risk assessment program 108 has the ability to instruct one or more systems on the traveling vehicle to perform the action in an autonomous manner or instruct the driver of the traveling vehicle to perform the action. Risk assessment program 108 utilizes the different categories of risk level and the updated overall risk assessment score to determine how to perform the action. For a subject vehicle in a high risk category with an overall risk assessment score at or below an immediate risk threshold level, risk assessment program 108 performs the action on the traveling vehicle without driver input or driver confirmation from the traveling vehicle to mitigate the risk as soon as possible. For a subject vehicle in the high risk category but with an overall risk assessment score above the immediate risk threshold level, risk assessment program 108 queries the driver of the traveling vehicle for a confirmation to perform the action to mitigate the risk. For low risk and moderate risk categories, risk assessment program 108 can display or audible play one or more recommended actions to the driver of the traveling vehicle to mitigate risk due to a subject vehicle located in the vicinity.

In one example, risk assessment program 108 instructs a traveling vehicle to perform an action without driver input or driver confirmation, where the action includes instructing a braking system on the traveling vehicle to apply brakes until a distance between the traveling vehicle and subject vehicle increases from 200 feet to 1500 feet. In the event an adaptive cruise control system is active on the traveling vehicle, risk assessment program 108 instructs the adaptive cruise control system to increase the distance between the traveling vehicle and the subject vehicle utilizing the front mount radar system on the traveling vehicle. In another example, risk assessment program 108 displays the action to be performed to the driver of the traveling vehicle, where the user can select to perform the action or decline the action via an input on the user interface. Responsive to receiving a confirmation from the driver of the traveling vehicle, risk assessment program 108 instructs one or more components (e.g., braking system, steering system, engine) on the traveling vehicle to perform the action. In yet another example, risk assessment program 108 performs the action by displaying and/or audibly playing the one or more actions the driver of the traveling vehicle can manual perform to mitigate the risk with respect to the subject vehicle. For instances where risk assessment program 108 determined no action is required based on the updated risk assessment, risk assessment program 108 determines to perform no action on the traveling vehicle. Alternatively, risk assessment program 108 displays a unique indicator viewable (e.g., heads-up display) by the driver of the traveling vehicle that no action is required based on the subject vehicle in the vicinity.

Risk assessment program 108 determines whether the identified vehicle is still in the vicinity (decision 216). In the event risk assessment program 108 determines the identified vehicle is no longer in the vicinity (“no” branch, decision 216), risk assessment program 108 determines whether the vehicle is still traveling (decision 218). In the event risk assessment program 108 determines the identified vehicle is still in the vicinity (“yes” branch, decision 216), risk assessment program 108 reverts back and receives (208) vehicle, driver, and environmental observations to generate another updated risk assessment for the identified vehicle.

Risk assessment program 108 determines whether the vehicle is still traveling (decision 218). In the event risk assessment program 108 determines the vehicle is still traveling (“yes” branch, decision 218), risk assessment program 108 reverts back to identifying a vehicle in a vicinity. In the event risk assessment program 108 determines the vehicle is no longer traveling (“no” branch, decision 218), risk assessment program 108 ceases operations.

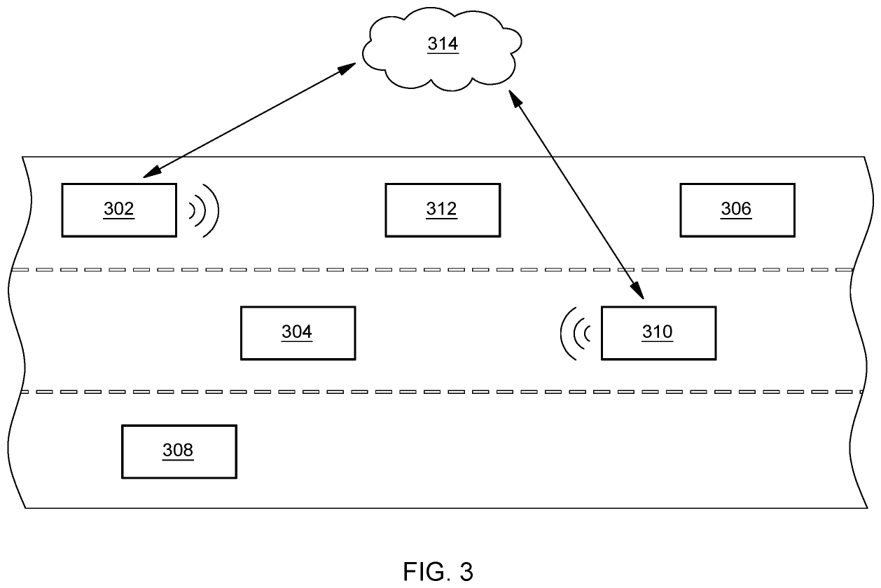

FIG. 3 illustrates an example of a traveling vehicle utilizing a risk assessment program, in accordance with an embodiment of the present invention. In this embodiment, traveling vehicle 302 is traveling along a motorway, where risk assessment program 108 identifies multiple vehicles in the vicinity of traveling vehicle 302 based on a direction of travel, a distance between each of the multiple vehicles, and a line of sight of one or more devices on traveling vehicle 302. Risk assessment program 108 identifies subject vehicle 304, 308, 310, and 312 as the multiple vehicles in the vicinity of traveling vehicle. Subject vehicle 306 is not located in a line of sight of the one or more device on traveling vehicle 302 and risk assessment program 108 has not previously received data for subject vehicle 306. Subject vehicle 310 is also not located in a line of sight of the one or more device on traveling vehicle 302 but risk assessment program 108 has previously received data for subject vehicle 310 which included location information indicating that subject vehicle 310 is in a vicinity of traveling vehicle 302. Subject vehicles 304, 308, and 312 are in the line of sight of the one or more devices on traveling vehicle 302 but risk assessment program 108 has not previously received data for any of subject vehicles 304, 308, and 312. In this example, cloud database 314 is utilized by risk assessment program 108 to receive and store data collected from traveling vehicle 302 and subject vehicle 310, along with any received vehicle, driver, and environment observation received from traveling vehicle 302 regarding any of subject vehicles 304, 308, 310, and 312. Risk assessment program 108 can determine to perform an action and instruct traveling vehicle 302 to perform the determined action based on an initial risk assessment for subject vehicle 310, where the risk assessment is based on the received data previously collected from subject vehicle 310 (i.e., an overall risk assessment score). Risk assessment program 108 can determined to perform an action and instruct traveling vehicle 302 to perform the determined action based on a risk assessment for subject vehicles 304, 308, and 312, where the risk assessment is based on received vehicle, driver, and environment observations.

FIG. 4 depicts computer system 400, where server computer 102 and electronic device 104 are examples of a computer system 400 that includes risk assessment program 108A and B, respectively. The computer system includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

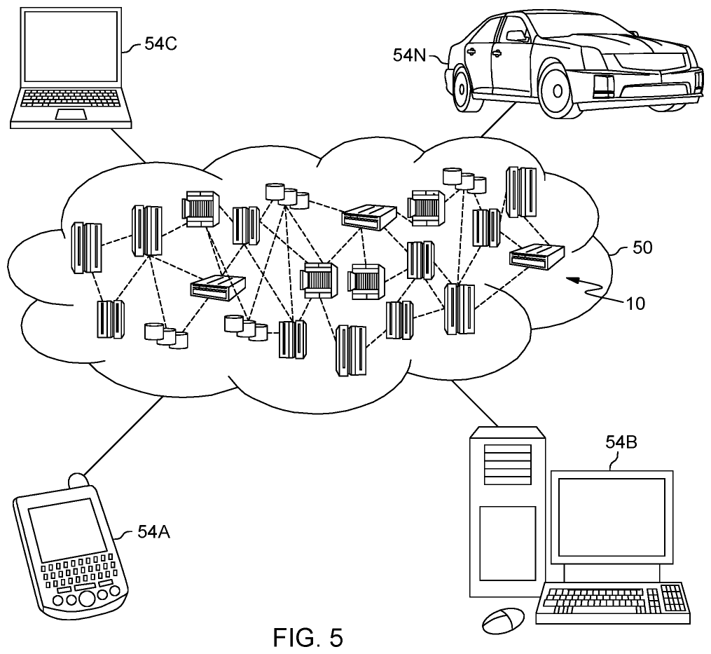

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

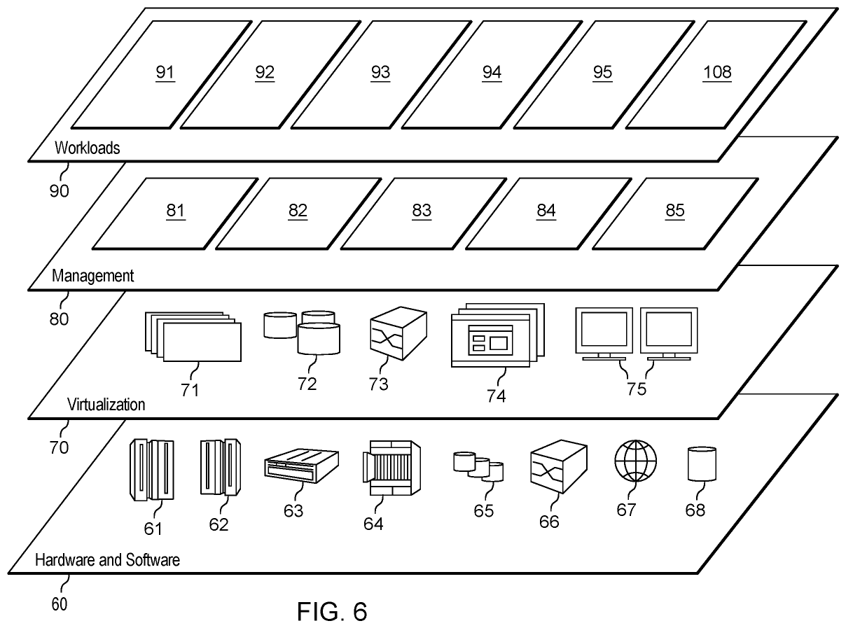

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and risk assessment program 108.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
identifying, by one or more processors, a subject vehicle in a vicinity of a traveling vehicle, wherein the vicinity is based on a direction of travel and a distance between the subject vehicle and the traveling vehicle;
receiving, by one or more processors, a plurality of observations from one or more devices on the traveling vehicle, wherein the plurality of observations includes at least one vehicle observation that identifies a feature on the subject vehicle that affects operational safety of the subject vehicle and the traveling vehicle;
generating, by one or more processors, an updated risk assessment score for the subject vehicle based on the one or more observations from the one or more device on the traveling vehicle and an initial risk assessment score for the subject vehicle; and
responsive to determining an action for the traveling vehicle to perform based on the updated risk assessment score for the subject vehicle, performing, by one or more processors, the action at the traveling vehicle.

2. The method of claim 1, wherein performing the action at the traveling vehicle further comprises:
responsive to determining the subject vehicle includes an updated risk assessment score meets or is below an immediate risk threshold, instructing, by one or more processors, one or more systems on the traveling vehicle to perform the action.

3. The method of claim 1, wherein performing the action at the traveling vehicle further comprises:
responsive to determining the subject vehicle includes an updated risk assessment score is above an immediate risk threshold, displaying, by one or more processors, in a user interface on the traveling vehicle, the action to be performed by one or more systems on the traveling vehicle; and
responsive to receiving a confirmation via a user input on the user interface to perform the action by the one or more systems on the traveling vehicle, instructing, by one or more processors, the one or more systems on the traveling vehicle to perform the action.

4. The method of claim 1, wherein the plurality of observations further includes at least one driver observation that affects operational safety of the subject vehicle and the traveling vehicle.

5. The method of claim 4, wherein the plurality of observations further includes at least one environmental observation that affects operational safety of the subject vehicle and the traveling vehicle.

6. The method of claim 1, further comprising:
receiving, by one or more processors, data collected by a plurality of devices on a plurality of vehicles, wherein the plurality of vehicles includes the traveling vehicle and the subject vehicle; and
generating, by one or more processors, the initial risk assessment score for the subject vehicle based on a portion of the data collected associated with the subject vehicle from the plurality of vehicles, wherein the portion of the data collected indicates at least one fault with a device on the subject vehicle.

7. The method of claim 6, wherein the device on the subject vehicle is selected from a group consisting of: a sensor, a camera, radar, an engine control unit, and a transmission control unit.

8. A computer program product comprising:
one or more computer readable storage media and program instructions stored on at least one of the one or more storage media, the program instructions comprising:
program instructions to identify a subject vehicle in a vicinity of a traveling vehicle, wherein the vicinity is based on a direction of travel and a distance between the subject vehicle and the traveling vehicle;
program instructions to receive a plurality of observations from one or more devices on the traveling vehicle, wherein the plurality of observations includes at least one vehicle observation that identifies a feature on the subject vehicle that affects operational safety of the subject vehicle and the traveling vehicle;
program instructions to generate an updated risk assessment score for the subject vehicle based on the one or more observations from the one or more device on the traveling vehicle and an initial risk assessment score for the subject vehicle; and
program instructions to, responsive to determining an action for the traveling vehicle to perform based on the updated risk assessment score for the subject vehicle, perform the action at the traveling vehicle.

9. The computer program product of claim 8, wherein performing the action at the traveling vehicle further comprises program instructions, stored on the one or more computer readable storage media, which when executed by a processor, cause the processor to:
responsive to determining the subject vehicle includes an updated risk assessment score meets or is below an immediate risk threshold, instruct one or more systems on the traveling vehicle to perform the action.

10. The computer program product of claim 8, wherein performing the action at the traveling vehicle further comprises program instructions, stored on the one or more computer readable storage media, which when executed by a processor, cause the processor to:
responsive to determining the subject vehicle includes an updated risk assessment score is above an immediate risk threshold, display in a user interface on the traveling vehicle, the action to be performed by one or more systems on the traveling vehicle; and
responsive to receiving a confirmation via a user input on the user interface to perform the action by the one or more systems on the traveling vehicle, instruct the one or more systems on the traveling vehicle to perform the action.

11. The computer program product of claim 8, wherein the plurality of observations further includes at least one driver observation that affects operational safety of the subject vehicle and the traveling vehicle.

12. The computer program product of claim 11, wherein the plurality of observations further includes at least one environmental observation that affects operational safety of the subject vehicle and the traveling vehicle.

13. The computer program product of claim 8, further comprising program instructions, stored on the one or more computer readable storage media, which when executed by a processor, cause the processor to:
receive data collected by a plurality of devices on a plurality of vehicles, wherein the plurality of vehicles includes the traveling vehicle and the subject vehicle; and
generate the initial risk assessment score for the subject vehicle based on a portion of the data collected associated with the subject vehicle from the plurality of vehicles, wherein the portion of the data collected indicates at least one fault with a device on the subject vehicle.

14. The computer program product of claim 13, wherein the device on the subject vehicle is selected from a group consisting of: a sensor, a camera, radar, an engine control unit, and a transmission control unit.

15. A computer system comprising:
one or more computer processors;
one or more computer readable storage media; and
program instructions stored on the computer readable storage media for execution by at least one of the one or more computer processors, the program instructions comprising:
program instructions to identify a subject vehicle in a vicinity of a traveling vehicle, wherein the vicinity is based on a direction of travel and a distance between the subject vehicle and the traveling vehicle;
program instructions to receive a plurality of observations from one or more devices on the traveling vehicle, wherein the plurality of observations includes at least one vehicle observation that identifies a feature on the subject vehicle that affects operational safety of the subject vehicle and the traveling vehicle;
program instructions to generate an updated risk assessment score for the subject vehicle based on the one or more observations from the one or more device on the traveling vehicle and an initial risk assessment score for the subject vehicle; and
program instructions to, responsive to determining an action for the traveling vehicle to perform based on the updated risk assessment score for the subject vehicle, perform the action at the traveling vehicle.

16. The computer system of claim 15, wherein performing the action at the traveling vehicle further comprises program instructions, stored on the one or more computer readable storage media, which when executed by a processor, cause the processor to:
responsive to determining the subject vehicle includes an updated risk assessment score meets or is below an immediate risk threshold, instruct one or more systems on the traveling vehicle to perform the action.

17. The computer system of claim 15, wherein performing the action at the traveling vehicle further comprises program instructions, stored on the one or more computer readable storage media, which when executed by a processor, cause the processor to:
responsive to determining the subject vehicle includes an updated risk assessment score is above an immediate risk threshold, display in a user interface on the traveling vehicle, the action to be performed by one or more systems on the traveling vehicle; and
responsive to receiving a confirmation via a user input on the user interface to perform the action by the one or more systems on the traveling vehicle, instruct the one or more systems on the traveling vehicle to perform the action.

18. The computer system of claim 15, wherein the plurality of observations further includes at least one driver observation that affects operational safety of the subject vehicle and the traveling vehicle.

19. The computer system of claim 18, wherein the plurality of observations further includes at least one environmental observation that affects operational safety of the subject vehicle and the traveling vehicle.

20. The computer system of claim 15, further comprising program instructions, stored on the one or more computer readable storage media, which when executed by a processor, cause the processor to:
receive data collected by a plurality of devices on a plurality of vehicles, wherein the plurality of vehicles includes the traveling vehicle and the subject vehicle; and
generate the initial risk assessment score for the subject vehicle based on a portion of the data collected associated with the subject vehicle from the plurality of vehicles, wherein the portion of the data collected indicates at least one fault with a device on the subject vehicle.
